(19) United States
(12) Patent Application Publication
(10) Pub. No.: US 2015/0260996 A1
(43) Pub. Date: Sep. 17, 2015

(54) HOLOGRAPHIC 3D DISPLAY DEVICE AND DISPLAY SYSTEM

(71) Applicant: SHENZHEN CHINA STAR OPTOELECTRONICS TECHNOLOGY CO., LTD, Shenzhen, Guangdong (CN)

(72) Inventors: Jianhong Chen, Shenzhen (CN); Bin Fang, Shenzhen (CN)

(73) Assignee: SHENZHEN CHINA STAR OPTOELECTRONICS TECHNOLOGY CO., LTD, Shenzhen, Guangdong (CN)

(21) Appl. No.: 14/360,633

(22) PCT Filed: Mar. 24, 2014
(86) PCT No.: PCT/CN2014/073951

§ 371 Date: May 26, 2014

(30) Foreign Application Priority Data
Mar. 11, 2014 (CN) 201410087506.0

(51) Int. Cl. G02B 27/09; G02F 1/1335

(52) U.S. Cl. CPC G02B 27/0944; G02F 1/1335

(57) ABSTRACT

The present invention provides a holographic 3D display device and display system. The holographic 3D display device comprises a two-dimensional liquid crystal display panel and a displaying pinhole array. The two-dimensional liquid crystal display panel comprises a plurality of image displaying elements. Pinholes of the displaying pinhole array and the image displaying elements have a one-to-one correspondence. The length at a light-entering side of the cross section of the pinhole is smaller than the length at a light-emitting side of the cross section of the pinhole. The present invention further provides a holographic 3D display system. The present invention improves the brightness of the display device.

### BACKGROUND OF THE INVENTION

1. Field of the Invention

The present invention relates to a liquid crystal technology, and more particularly, to a holographic three-dimensional (3D) display device and display system.

2. Description of Prior Art

Holography is a technique provided by M. G. Lippmann in 1908, which enables three-dimensional images with whole scene to be made. The principle of this technique is to use a pinhole array or a micro lens array to record a scene on a photographic plate disposed in the rear of the pinhole array or the micro lens array. Each image element on the photographic plate behind each corresponding pinhole or micro lens records a part of information of the scene. An image element array consisted of all the gathered image elements records three-dimensional information of the whole scene. On a basis of principle of reversibility of light, if another pinhole array or micro lens array identical to the pinhole array or micro lens array used in the recording step is placed in the front of the image element array, the original three-dimensional scene can be reconstructed in the front of said another pinhole array or micro lens array.

Please refer to FIG. 1 and FIG. 2. FIG. 1 is a schematic structural diagram showing a conventional holographic 3D display system. FIG. 2 is a schematic structural diagram showing one display unit of a conventional holographic 3D display device. The holographic 3D display system 10 comprises a holographic 3D gathering device 11 and a holographic 3D display device 12. The holographic 3D gathering device 11 comprises an image gathering transducer 111 and a gathering pinhole array 112. The image gathering transducer 111 comprises a plurality of gathering units 113 that are utilized for gathering information about a three-dimensional scene from various viewing angles. The gathering pinhole array 112 is utilized for transforming a three-dimensional image of the three-dimensional scene into three-dimensional scene information for the respective viewing angles. The holographic 3D display device 12 comprises a two-dimensional liquid crystal display panel 121 and a displaying pinhole array 122. The two-dimensional liquid crystal display panel 121 comprises a plurality of image displaying elements 123 that are utilized for presenting information about the three-dimensional scene from various viewing angles. The displaying pinhole array 122 is utilized for constructing the three-dimensional image for the three-dimensional scene from the three-dimensional scene information presented by corresponding image displaying elements 123.

The gathering units 113 of the image gathering transducer 111 and pinholes 114 of the gathering pinhole array 112 have a one-to-one correspondence. The gathering units 113 of the image gathering transducer 111 and the image displaying elements 123 of the two-dimensional liquid crystal display panel 121 have a one-to-one correspondence. The image displaying elements 123 of the two-dimensional liquid crystal display panel 121 and pinholes 124 of the displaying pinhole array 122 have a one-to-one correspondence. In FIG. 2, one display unit comprises one pinhole 124 of the displaying pinhole array 122 and a corresponding image displaying element 123. The viewing angle of the holographic 3D display device 12 is θₐ as shown in FIG. 2.

Compared to the holographic 3D display device made based on the micro lens array, the holographic 3D display device made based on the pinhole array has many advantages including low cost, less weight, thin device, and its pitches not limited to fabricating methods. However, the brightness of the holographic 3D display device made based on the pinhole array is apparently less than that of the holographic 3D display device made based on the micro lens array. If simply increasing the aperture of pinhole of the pinhole array to increase the brightness of the three-dimensional image, the viewing angle will be decreased accordingly, thereby restricting practical applications of the holographic 3D display device made based on the pinhole array.

Therefore, there is a need to provide a holographic 3D display device and display system for solving above technical problems occurred in the existing technical skills.

### SUMMARY OF THE INVENTION

The objective of the present invention is to provide a holographic 3D display device and a holographic 3D display system with high brightness and a wide viewing angle based on a pinhole array, for solving the technical problems including low brightness and narrow viewing angle in the conventional holographic 3D display device and the conventional holographic 3D display system.

To solve above technical problems, the present invention provides following technical schemes.

The present invention provides a holographic 3D display device, comprising:

a two-dimensional liquid crystal display panel, which comprises a plurality of image displaying elements for presenting information about a three-dimensional scene from various viewing angles;

a displaying pinhole array for constructing a three-dimensional image for the three-dimensional scene from three-dimensional scene information presented by corresponding image displaying elements; and

light barriers disposed at borders of the image displaying elements, for preventing the three-dimensional scene information of adjacent image displaying elements from being interfered with each other;

wherein pinholes of the displaying pinhole array and the image displaying elements have a one-to-one correspondence, a length at a light-entering side of a cross section of the pinhole is smaller than a length at a light-emitting side of the cross section of the pinhole, the light-entering side of the cross section of the pinhole is near the two-dimensional liquid crystal display panel, and the light-emitting side of the cross section of the pinhole is far away from the two-dimensional liquid crystal display panel.

The cross section of the pinhole is shaped as a trapezoid or has a trapezoid-like shape.

In the holographic 3D display device of the present invention, if the cross section of the pinhole is shaped as a trapezoid, the length b at the light-emitting side of the trapezoid satisfies:

$$\frac{b - a}{2 d} \geq \frac{p + a}{2 g} ,$$

where a is the length at the light-entering side of the trapezoid, d is a height of the trapezoid, p is a length of a cross section of the image displaying element, and g is a distance between the light-entering side of the trapezoid and the cross section of the image displaying element.

In the holographic 3D display device of the present invention, the length b at the light-emitting side of the trapezoid satisfies:

$$\frac{b - a}{2 d} = \frac{p + a}{2 g} .$$

The present invention further provides a holographic 3D display device, comprising:

a two-dimensional liquid crystal display panel, which comprises a plurality of image displaying elements for presenting information about a three-dimensional scene from various viewing angles; and

a displaying pinhole array for constructing a three-dimensional image for the three-dimensional scene from three-dimensional scene information presented by corresponding image displaying elements;

wherein pinholes of the displaying pinhole array and the image displaying elements have a one-to-one correspondence, a length at a light-entering side of a cross section of the pinhole is smaller than a length at a light-emitting side of the cross section of the pinhole, the light-entering side of the cross section of the pinhole is near the two-dimensional liquid crystal display panel, and the light-emitting side of the cross section of the pinhole is far away from the two-dimensional liquid crystal display panel.

In the holographic 3D display device of the present invention, the cross section of the pinhole is shaped as a trapezoid.

In the holographic 3D display device of the present invention, the cross section of the pinhole has a trapezoid-like shape.

In the holographic 3D display device of the present invention, if the cross section of the pinhole is shaped as a trapezoid, the length b at the light-emitting side of the trapezoid satisfies:

$$\frac{b - a}{2 d} \geq \frac{p + a}{2 g} ,$$

where a is the length at the light-entering side of the trapezoid, d is a height of the trapezoid, p is a length of a cross section of the image displaying element, and g is a distance between the light-entering side of the trapezoid and the cross section of the image displaying element.

In the holographic 3D display device of the present invention, the length b at the light-emitting side of the trapezoid satisfies:

$$\frac{b - a}{2 d} = \frac{p + a}{2 g} .$$

In the holographic 3D display device of the present invention, the holographic 3D display device further comprises:

light barriers disposed at borders of the image displaying elements, for preventing the three-dimensional scene information of adjacent image displaying elements from being interfered with each other.

The present invention further provides a holographic 3D display system, comprising:

a holographic 3D gathering device, which comprises:
an image gathering transducer comprising a plurality of gathering units for gathering information about a three-dimensional scene from various viewing angles; and
a gathering pinhole array for transforming a three-dimensional image of the three-dimensional scene into three-dimensional scene information for the respective viewing angles;

a holographic 3D display device, which comprises:
a two-dimensional liquid crystal display panel comprising a plurality of image displaying elements for presenting information about the three-dimensional scene from various viewing angles; and
a displaying pinhole array for constructing the three-dimensional image for the three-dimensional scene from the three-dimensional scene information presented by corresponding image displaying elements;

wherein pinholes of the displaying pinhole array and the image displaying elements have a one-to-one correspondence, a length at a light-entering side of a cross section of the pinhole is smaller than a length at a light-emitting side of the cross section of the pinhole, the light-entering side of the cross section of the pinhole is near the two-dimensional liquid crystal display panel, and the light-emitting side of the cross section of the pinhole is far away from the two-dimensional liquid crystal display panel.

In the holographic 3D display system of the present invention, the cross section of the pinhole of the displaying pinhole array is shaped as a trapezoid.

In the holographic 3D display system of the present invention, the cross section of the pinhole of the displaying pinhole array has a trapezoid-like shape.

In the holographic 3D display system of the present invention, the cross section of the pinhole of the gathering pinhole array is shaped as a rectangle or a square.

In the holographic 3D display system of the present invention, if the cross section of the pinhole of the displaying pinhole array is shaped as a trapezoid, the length b at the light-emitting side of the trapezoid satisfies:

$$\frac{b - a}{2 d} \geq \frac{p + a}{2 g} ,$$

where a is the length at the light-entering side of the trapezoid, d is a height of the trapezoid, p is a length of a cross section of the image displaying element, and g is a distance between the light-entering side of the trapezoid and the cross section of the image displaying element.

In the holographic 3D display system of the present invention, the length b at the light-emitting side of the trapezoid satisfies:

$$\frac{b - a}{2 d} = \frac{p + a}{2 g} .$$

In the holographic 3D display system of the present invention, the holographic 3D display device further comprises:

light barriers disposed at borders of the image displaying elements, for preventing the three-dimensional scene information of adjacent image displaying elements from being interfered with each other.

Compared to a conventional holographic 3D display device and display system, the holographic 3D display device and display system of the present invention enlarges the viewing angle of the display device and improves the brightness of the display device by arranging the length of the light-entering side of the cross section of the pinhole of the displaying pinhole array not equal to that of the light-emitting side of the cross section of the pinhole of the displaying pinhole array, thereby solving the technical problems including low brightness and narrow viewing angle in the conventional holographic 3D display device and the conventional holographic 3D display system.

To make above content of the present invention more easily understood, it will be described in details by using preferred embodiments in conjunction with the appending drawings.

### BRIEF DESCRIPTION OF THE DRAWINGS

FIG. 1 is a schematic structural diagram showing a conventional holographic 3D display system.

FIG. 2 is a schematic structural diagram showing one display unit of a conventional holographic 3D display device.

FIG. 3 is a schematic structural diagram showing a holographic 3D display system in accordance with a first preferred embodiment of the present invention.

FIG. 4 is a schematic structural diagram showing one display unit of a holographic 3D display device in accordance with the first preferred embodiment of the present invention.

FIG. 5A to FIG. 5C are schematic diagrams showing cross sections of pinholes of a displaying pinhole array in a holographic 3D display device of the present invention.

FIG. 6 is a schematic structural diagram showing a holographic 3D display system in accordance with a second preferred embodiment of the present invention.

FIG. 7 is a schematic structural diagram showing one display unit of a holographic 3D display device in accordance with the second preferred embodiment of the present invention.

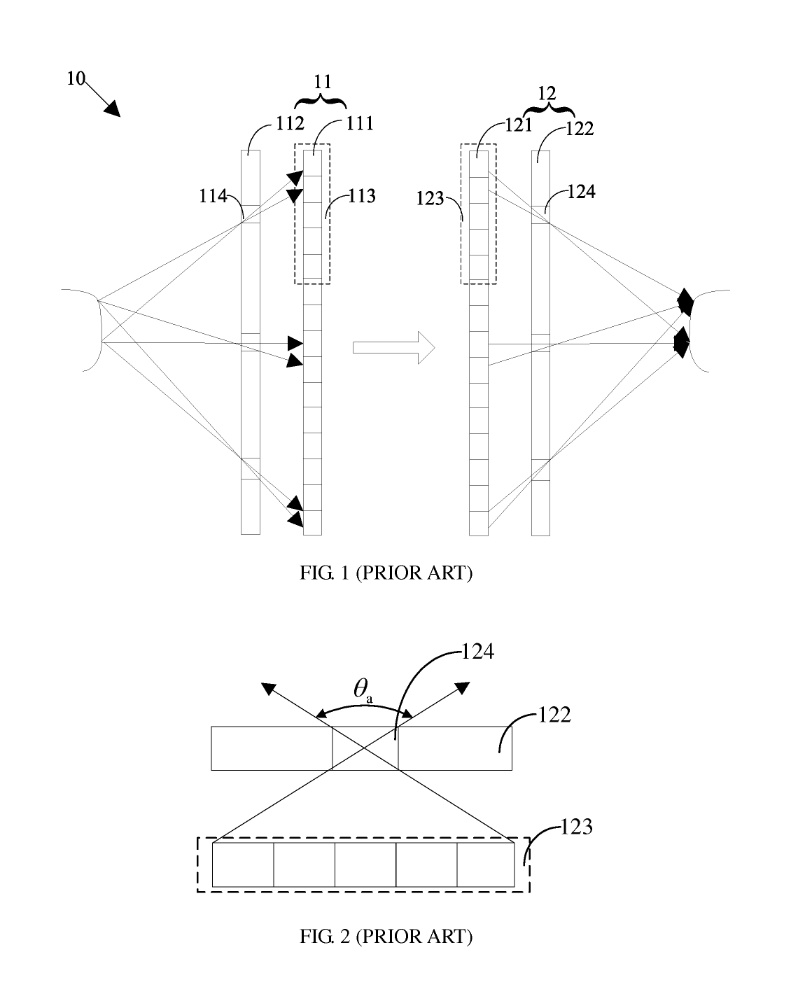

### DETAILED DESCRIPTION OF THE PREFERRED EMBODIMENTS

The following descriptions for the respective embodiments are specific embodiments capable of being implemented for illustrations of the present invention with referring to appended figures. In the descriptions of the present invention, spatially relative terms, such as “upper”, “lower”, “front”, “back”, “left”, “right”, “inner”, “outer”, “lateral”, and the like, may be used herein for ease of description as illustrated in the figures. Therefore, it will be understood that the spatially relative terms are intended to illustrate for understanding the present invention, but not to limit the present invention.

In the appending drawings, units having similar structures are labeled by the same reference numbers.

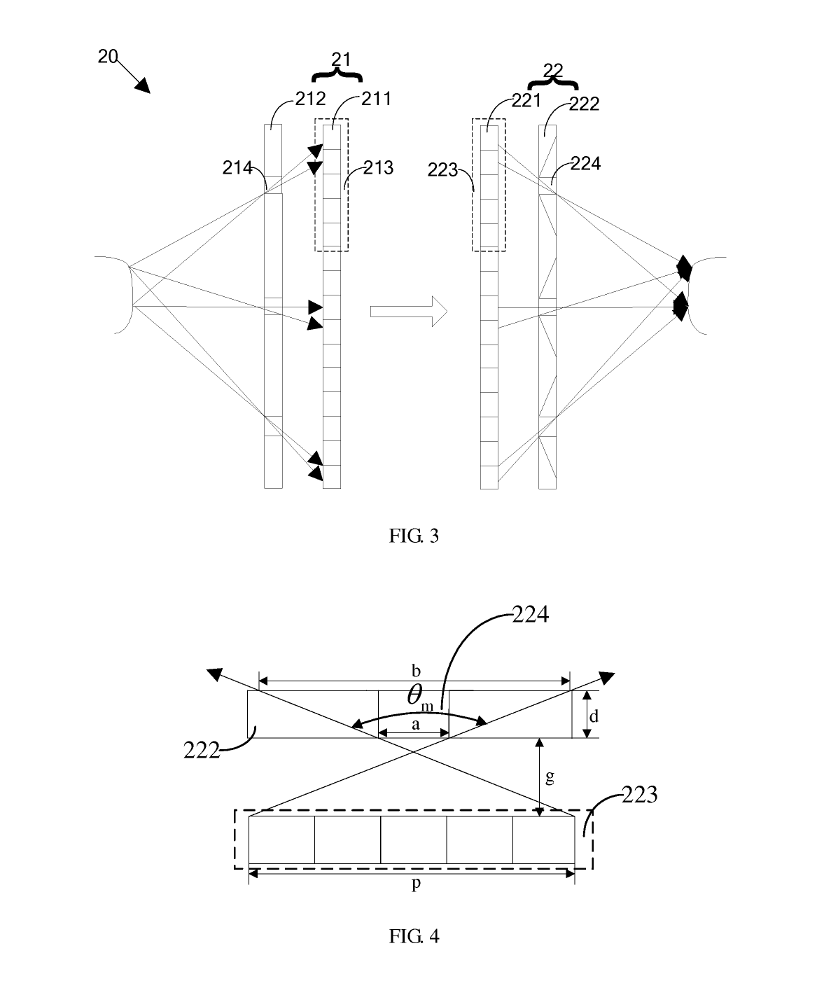

Please refer to FIG. 3 and FIG. 4. FIG. 3 is a schematic structural diagram showing a holographic three-dimensional (3D) display system in accordance with a first preferred embodiment of the present invention. FIG. 4 is a schematic structural diagram showing one display unit of a holographic 3D display device in accordance with the first preferred embodiment of the present invention. The holographic 3D display system 20 of the present preferred embodiment comprises a holographic 3D gathering device 21 and a holographic 3D display device 22. The holographic 3D gathering device 21 comprises an image gathering transducer 211 and a gathering pinhole array 212. The image gathering transducer 211 comprises a plurality of gathering units 213 that are utilized for gathering information about a three-dimensional scene from various viewing angles. The gathering pinhole array 212 is utilized for transforming a three-dimensional image of the three-dimensional scene into three-dimensional scene information for the respective viewing angles. The holographic 3D display device 22 comprises a two-dimensional liquid crystal display panel 221 and a displaying pinhole array 222. The two-dimensional liquid crystal display panel 221 comprises a plurality of image displaying elements 223 that are utilized for presenting information about the three-dimensional scene from various viewing angles. The displaying pinhole array 222 is utilized for constructing the three-dimensional image for the three-dimensional scene from the three-dimensional scene information presented by corresponding image displaying elements 223.

The gathering units 213 of the image gathering transducer 211 and pinholes 214 of the gathering pinhole array 212 have a one-to-one correspondence. The gathering units 213 of the image gathering transducer 211 and the image displaying elements 223 of the two-dimensional liquid crystal display panel 221 have a one-to-one correspondence. The image displaying elements 223 of the two-dimensional liquid crystal display panel 221 and pinholes 224 of the displaying pinhole array 222 have a one-to-one correspondence.

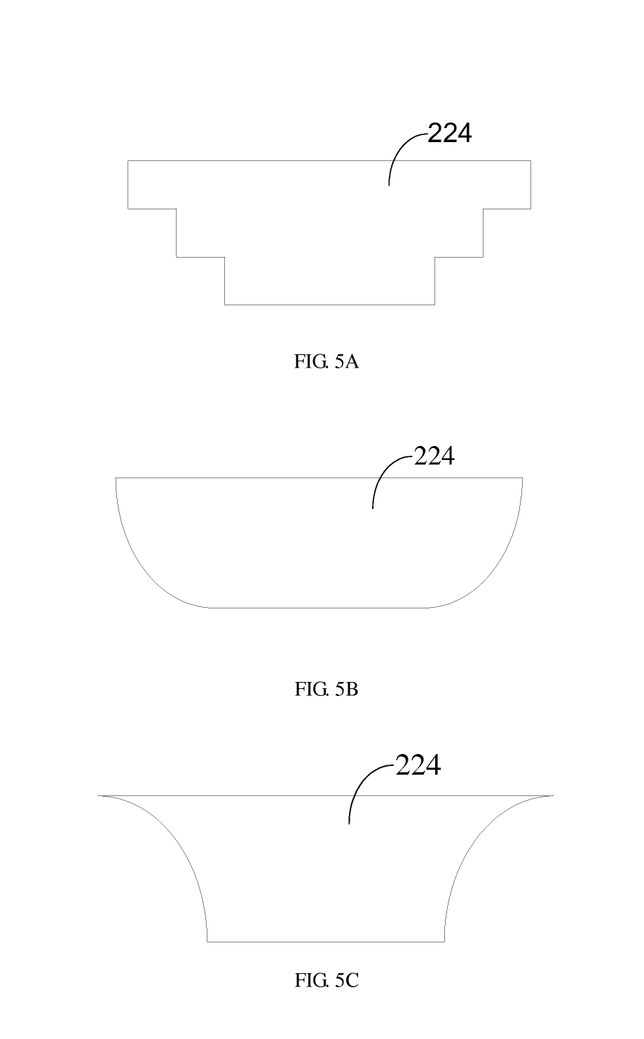

In the present preferred embodiment, the length at a light-entering side of the cross section of the pinhole 224 of the displaying pinhole array 222 is smaller than the length at a light-emitting side of the cross section of the pinhole 224 of the displaying pinhole array 224. The light-entering side of the cross section of the pinhole 224 of the displaying pinhole array 222 is near the two-dimensional liquid crystal display panel 221. The light-emitting side of the cross section of the pinhole 224 of the displaying pinhole array 222 is far away from the two-dimensional liquid crystal display panel 221. As shown in FIG. 4, the cross section of the pinhole 224 of the displaying pinhole array 222 can be shaped as a trapezoid or has a trapezoid-like shape (including the shapes shown in FIG. 5A to FIG. 5C, but not limited thereto).

If the cross section of the pinhole 224 of the displaying pinhole array 222 is a trapezoid, the ladder-shaped cross section satisfies:

$$\frac{b - a}{2 d} \geq \frac{p + a}{2 g} ,$$

where b is the length at the light-emitting side of the ladder-shaped cross section, a is the length at the light-entering side of the ladder-shaped cross section, d is the height of the ladder-shaped cross section, p is a length of the cross section of the image displaying element 223, and g is a distance between the light-entering side of the ladder-shaped cross section and the cross section of the image displaying element 223.

Preferrably, when

$$\frac{b - a}{2 d} = \frac{p + a}{2 g} ,$$

the viewing angle of the holographic 3D display device 22 is

$${θ}_{m} = 2 arctan ( \frac{p + a}{2 g} ) .$$

When

$$\frac{b - a}{2 d} < \frac{p + a}{2 g} ,$$

the viewing angle of the holographic 3D display device 22 is

$${θ}_{m} = 2 acrtan ( \frac{b - a}{2 d} ) .$$

However, the viewing angle of the conventional holographic 3D display device is

$${θ}_{a} = 2 acrtan ( \frac{p - a}{2 g} ) = 2 acrtan ( \frac{a}{d} ) .$$

Therefore, the viewing angle θₘ of the holographic 3D display device 22 of the present preferred embodiment is larger than the viewing angle θₐ of the conventional holographic 3D display device

$$( i . e . , \frac{p + a}{2 g} > \frac{p - a}{2 g} ) .$$

To make sure to get a much greater viewing angle θₘ, it can make

$$\frac{b - a}{2 d}$$

slightly greater than

$$\frac{p + a}{2 g} , i . e . , \frac{b - a}{2 d} \geq \frac{p + a}{2 g} .$$

Meanwhile, the viewing angle is

$${θ}_{m} = 2 acrtan ( \frac{p + a}{2 g} ) .$$

In order to ensure that the viewing angle of the holographic 3D display device 22 is sufficiently large, the gathering pinhole array 212 utilized in the conventional skill (i.e., the cross section of the pinhole 214 of the gathering pinhole array 212 of the holographic 3D gathering device 21 should be a rectangle or a square) should be used for gathering the three-dimensional scene information with various angles when utilizing the holographic 3D display system 20 of the present preferred embodiment and gathering images by using the holographic 3D gathering device 21, so as to avoid gathering the three-dimensional scene information at a large viewing angle and eliminating the enlargement effect of the viewing angle of the holographic 3D display device 22.

The holographic 3D display system of the present preferred embodiment enlarges the viewing angle of the holographic 3D display device and improves the brightness of the holographic 3D display device by arranging the length of the light-entering side of the cross section of the pinhole not equal to that of the light-emitting side of the cross section of the pinhole for the holographic 3D display device, i.e., the length at the light-entering side of the cross section of the pinhole is smaller than the length at the light-emitting side of the cross section of the pinhole.

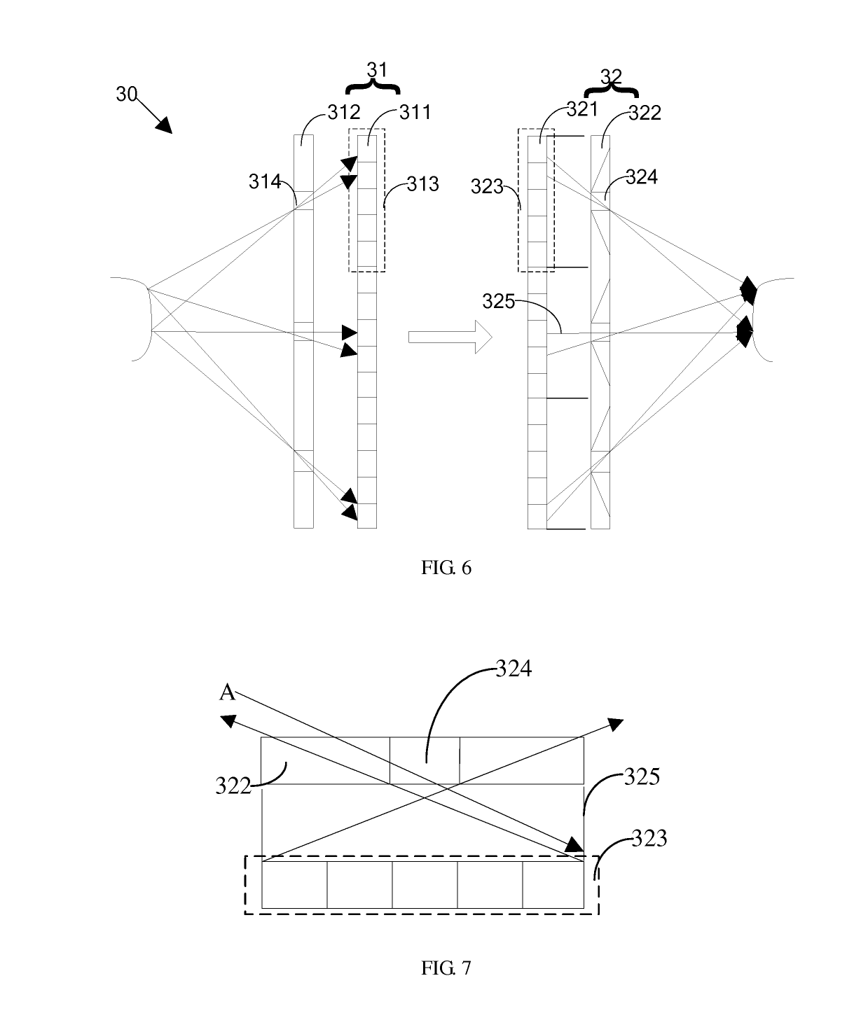

Please refer to FIG. 6 and FIG. 7. FIG. 6 is a schematic structural diagram showing a holographic three-dimensional (3D) display system in accordance with a second preferred embodiment of the present invention. FIG. 7 is a schematic structural diagram showing one display unit of a holographic 3D display device in accordance with the second preferred embodiment of the present invention. The holographic 3D display system 30 of the present preferred embodiment comprises a holographic 3D gathering device 31 and a holographic 3D display device 32. The holographic 3D gathering device 31 comprises an image gathering transducer 311 and a gathering pinhole array 312. The image gathering transducer 311 comprises a plurality of gathering units 313 that are utilized for gathering information about a three-dimensional scene from various viewing angles. The gathering pinhole array 312 is utilized for transforming a three-dimensional image of the three-dimensional scene into three-dimensional scene information for the respective viewing angles. The holographic 3D display device 32 comprises a two-dimensional liquid crystal display panel 321 and a displaying pinhole array 322. The two-dimensional liquid crystal display panel 321 comprises a plurality of image displaying elements 323 that are utilized for presenting information about the three-dimensional scene from various viewing angles. The displaying pinhole array 322 is utilized for constructing the three-dimensional image for the three-dimensional scene from the three-dimensional scene information presented by corresponding image displaying elements 323.

The gathering units 313 of the image gathering transducer 311 and pinholes 314 of the gathering pinhole array 312 have a one-to-one correspondence. The gathering units 313 of the image gathering transducer 311 and the image displaying elements 323 of the two-dimensional liquid crystal display panel 321 have a one-to-one correspondence. The image displaying elements 323 of the two-dimensional liquid crystal display panel 321 and pinholes 324 of the displaying pinhole array 322 have a one-to-one correspondence.

The difference between the holographic 3D display system 30 of the present preferred embodiment and the first preferred embodiment is that the holographic 3D display device 32 further comprises light barriers 325, which are disposed at borders of the image displaying elements 323 and are utilized for preventing the three-dimensional scene information of adjacent image displaying elements 323 from being interfered with each other.

Referring to FIG. 7, a user A may view images from adjacent image displaying elements 323 through the pinhole 324 of the displaying pinhole array 322 when the cross section of the pinhole 324 is shaped as a trapezoid or has a trapezoid-like shape. That is, the user may view images from at least two image displaying elements 323 through the pinhole 324 of displaying pinhole array 322. This may make the three-dimensional scene information of adjacent image displaying elements 323 interfered with each other and thus affect the displaying quality of the holographic 3D display device 32.

In the present preferred embodiment, each image displaying element 323 has the light barrier 325 disposed on the border thereof. In such a manner, the user only can perceive the three-dimensional scene information of one image displaying element 323 through the pinhole 324 of the displaying pinhole array 322, thereby preventing the three-dimensional scene information of adjacent image displaying elements 323 from being interfered with each other and improving the displaying quality of the holographic 3D display device 32.

On a basis of the first preferred embodiment, the holographic 3D display system of the present preferred embodiment avoids the interference occurred between adjacent image displaying elements by arranging the light barriers at the borders of the image displaying elements, thereby improving the displaying quality of the holographic 3D display device.

The holographic 3D display device and the holographic 3D display system of the present invention enlarges the viewing angle of the display device and improves the brightness of the display device by arranging the length of the light-entering side of the cross section of the pinhole of the displaying pinhole array not equal to that of the light-emitting side of the cross section of the pinhole of the displaying pinhole array, thereby solving the technical problems including low brightness and narrow viewing angle in the conventional holographic 3D display device and the conventional holographic 3D display system

Although the present invention has been explained by the embodiments shown in the drawings described above, it should be understood to the ordinary skilled person in the art that the invention is not limited to the embodiments, but rather various changes or modifications thereof are possible without departing from the spirit of the invention. Accordingly, the scope of the invention shall be determined only by the appended claims and their equivalents.

What is claimed is:

1. A holographic 3D display device, comprising:
a two-dimensional liquid crystal display panel, which comprises a plurality of image displaying elements for presenting information about a three-dimensional scene from various viewing angles;
a displaying pinhole array for constructing a three-dimensional image for the three-dimensional scene from three-dimensional scene information presented by corresponding image displaying elements; and
light barriers disposed at borders of the image displaying elements, for preventing the three-dimensional scene information of adjacent image displaying elements from being interfered with each other;
wherein pinholes of the displaying pinhole array and the image displaying elements have a one-to-one correspondence, a length at a light-entering side of a cross section of the pinhole is smaller than a length at a light-emitting side of the cross section of the pinhole, the light-entering side of the cross section of the pinhole is near the two-dimensional liquid crystal display panel, and the light-emitting side of the cross section of the pinhole is far away from the two-dimensional liquid crystal display panel.

2. The holographic 3D display device according to claim 1, wherein the cross section of the pinhole is shaped as a trapezoid and the length b at the light-emitting side of the trapezoid satisfies:
$$\frac{b - a}{2 d} \geq \frac{p + a}{2 g} ,$$
where a is the length at the light-entering side of the trapezoid, d is a height of the trapezoid, p is a length of a cross section of the image displaying element, and g is a distance between the light-entering side of the trapezoid and the cross section of the image displaying element.

3. The holographic 3D display device according to claim 2, wherein the length b at the light-emitting side of the trapezoid satisfies:
$$\frac{b - a}{2 d} = \frac{p + a}{2 g} .$$

4. A holographic 3D display device, comprising:
a two-dimensional liquid crystal display panel, which comprises a plurality of image displaying elements for presenting information about a three-dimensional scene from various viewing angles; and
a displaying pinhole array for constructing a three-dimensional image for the three-dimensional scene from three-dimensional scene information presented by corresponding image displaying elements;
wherein pinholes of the displaying pinhole array and the image displaying elements have a one-to-one correspondence, a length at a light-entering side of a cross section of the pinhole is smaller than a length at a light-emitting side of the cross section of the pinhole, the light-entering side of the cross section of the pinhole is near the two-dimensional liquid crystal display panel, and the light-emitting side of the cross section of the pinhole is far away from the two-dimensional liquid crystal display panel.

5. The holographic 3D display device according to claim 4, wherein the cross section of the pinhole is shaped as a trapezoid.

6. The holographic 3D display device according to claim 4, wherein the cross section of the pinhole has a trapezoid-like shape.

7. The holographic 3D display device according to claim 5, wherein the length b at the light-emitting side of the trapezoid satisfies:
$$\frac{b - a}{2 d} \geq \frac{p + a}{2 g} ,$$
where a is the length at the light-entering side of the trapezoid, d is a height of the trapezoid, p is a length of a cross section of the image displaying element, and g is a distance between the light-entering side of the trapezoid and the cross section of the image displaying element.

8. The holographic 3D display device according to claim 7, wherein the length b at the light-emitting side of the trapezoid satisfies:
$$\frac{b - a}{2 d} = \frac{p + a}{2 g} .$$

9. The holographic 3D display device according to claim 4, further comprising:
light barriers disposed at borders of the image displaying elements, for preventing the three-dimensional scene information of adjacent image displaying elements from being interfered with each other.

10. A holographic 3D display system, comprising:
a holographic 3D gathering device, which comprises:
an image gathering transducer comprising a plurality of gathering units for gathering information about a three-dimensional scene from various viewing angles; and
a gathering pinhole array for transforming a three-dimensional image of the three-dimensional scene into three-dimensional scene information for the respective viewing angles;
a holographic 3D display device, which comprises:
a two-dimensional liquid crystal display panel comprising a plurality of image displaying elements for presenting information about the three-dimensional scene from various viewing angles; and
a displaying pinhole array for constructing the three-dimensional image for the three-dimensional scene from the three-dimensional scene information presented by corresponding image displaying elements;
wherein pinholes of the displaying pinhole array and the image displaying elements have a one-to-one correspondence, a length at a light-entering side of a cross section of the pinhole is smaller than a length at a light-emitting side of the cross section of the pinhole, the light-entering side of the cross section of the pinhole is near the two-dimensional liquid crystal display panel, and the light-emitting side of the cross section of the pinhole is far away from the two-dimensional liquid crystal display panel.

11. The holographic 3D display system according to claim 10, wherein the cross section of the pinhole of the displaying pinhole array is shaped as a trapezoid.

12. The holographic 3D display system according to claim 10, wherein the cross section of the pinhole of the displaying pinhole array has a trapezoid-like shape.

13. The holographic 3D display system according to claim 10, wherein the cross section of the pinhole of the gathering pinhole array is shaped as a rectangle or a square.

14. The holographic 3D display system according to claim 11, wherein the length b at the light-emitting side of the trapezoid satisfies:
$$\frac{b - a}{2 d} \geq \frac{p + a}{2 g} .$$
where a is the length at the light-entering side of the trapezoid, d is a height of the trapezoid, p is a length of a cross section of the image displaying element, and g is a distance between the light-entering side of the trapezoid and the cross section of the image displaying element.

15. The holographic 3D display system according to claim 14, wherein the length b at the light-emitting side of the trapezoid satisfies:
$$\frac{b - a}{2 d} = \frac{p + a}{2 g} .$$

16. The holographic 3D display system according to claim 10, further comprising:
light barriers disposed at borders of the image displaying elements, for preventing the three-dimensional scene information of adjacent image displaying elements from being interfered with each other.
